(19) United States
(12) Patent Application Publication
(10) Pub. No.: US 2012/0241272 A1
(43) Pub. Date: Sep. 27, 2012

(54) HYDRAULIC CONTROL DEVICE

(75) Inventors: Tomoya JINNO, Nishio (JP); Masamichi YAMAGUCHI, Anjo (JP); Tetsuya SHIMIZU, Anjo (JP); Kenichi TSUCHIDA, Nishio (JP); Kazunori ISHIKAWA, Toyota (JP)

(73) Assignee: AISIN AW CO., LTD., Anjo-shi (JP)

(21) Appl. No.: 13/427,220

(22) Filed: Mar. 22, 2012

(30) Foreign Application Priority Data
Mar. 22, 2011 (JP) 2011-062413

(51) Int. Cl. F16H 45/00; F16D 25/12

(52) U.S. Cl. 192/3.29; 192/85.63; 192/85.61

(57) ABSTRACT

A hydraulic control device controls a hydraulic pressure in an engagement side oil chamber defined on one side of a piston that configures a hydraulic clutch, and a hydraulic pressure in a back-pressure side oil chamber defined on the other side of the piston. The hydraulic control device includes a line pressure generating valve that generates a line pressure by adjusting a hydraulic pressure from an oil pump; a secondary pressure generating valve that generates a secondary pressure, which is a hydraulic pressure supplied to the back-pressure side oil chamber, by adjusting a hydraulic pressure from the line pressure generating valve so as to be lower than the line pressure; and a clutch engagement pressure generating valve that generates a clutch engagement pressure, which is a hydraulic pressure supplied to the engagement side oil chamber, by adjusting the line pressure from the line pressure generating valve.

### INCORPORATION BY REFERENCE

The disclosure of Japanese Patent Application No. 2011-062413 filed on Mar. 22, 2011 including the specification, drawings and abstract is incorporated herein by reference in its entirety.

### BACKGROUND OF THE INVENTION

The present invention relates to a hydraulic control device that controls a difference in pressure between an engagement side oil chamber defined on one side of a piston that configures a clutch, and a back-pressure side oil chamber defined on the other side of the piston.

### Description of the Related Art

An example of this type of hydraulic control device proposed in the past is a hydraulic control device for an automatic transmission that includes a linear solenoid valve that outputs a control pressure based on a throttle opening; a primary regulator valve that generates a line pressure based on the control pressure; and a secondary regulator valve that generates a secondary pressure that is lower than the line pressure and based on the control pressure from the linear solenoid valve, wherein the secondary pressure is supplied to a lock-up clutch and a torque converter (e.g., see Japanese Patent Application Publication No. 2006-349007 (JP 2006-349007 A)). The secondary regulator valve of this hydraulic control device includes a spool that has a large diameter portion formed on one axial side and a small diameter portion formed on the other axial side; a first oil chamber that applies the control pressure using an end portion of the spool on the other axial side; a second oil chamber that applies a feedback pressure of the secondary pressure using an end portion of the spool on the one axial side; and a third oil chamber that is formed between the large diameter portion and the small diameter portion of the spool, and is supplied with the line pressure when the lock-up clutch is engaged. The secondary regulator valve is also configured such that the secondary pressure when the line pressure is supplied to the third oil chamber is higher than when the line pressure is not supplied to the third oil chamber.

In the hydraulic control device thus configured, to disengage the lock-up clutch, the line pressure is not supplied to the third oil chamber of the secondary regulator valve, and the secondary regulator valve generates the secondary pressure based on the control pressure applied to the first oil chamber and the feedback pressure applied to the second oil chamber. The generated secondary pressure is then supplied to the torque converter. On the other hand, to engage the lock-up clutch, the line pressure is supplied to the third oil chamber, whereby the secondary regulator valve generates a higher secondary pressure than the secondary pressure generated to disengage the lock-up clutch. To engage the lock-up clutch, the secondary pressure generated by the secondary regulator valve is then supplied to the torque converter after being reduced by a check valve that includes a plunger and a spring, and the secondary pressure generated by the secondary regulator valve is also supplied to the lock-up clutch through a lock-up control valve.

### SUMMARY OF THE INVENTION

However, due to the low pressure-regulating ability of the check valve and the fact that the pressure of hydraulic oil varies depending on the temperature of the hydraulic oil, it is not easy in the conventional hydraulic control device to suitably set a difference in pressure between the front and back of the piston that configures the lock-up clutch. As a consequence, the linear solenoid valve that outputs the control pressure must be carefully and meticulously controlled.

The present invention can more suitably set a difference in pressure between an engagement side oil chamber defined on one side of a piston that configures a clutch, and a back-pressure side oil chamber defined on the other side of the piston, without making a control more complex.

The hydraulic control device of the present invention employs the following to achieve the above.

A hydraulic control device according to the present invention controls a hydraulic pressure in an engagement side oil chamber defined on one side of a piston that configures a hydraulic clutch, and a hydraulic pressure in a back-pressure side oil chamber defined on the other side of the piston. The hydraulic control device includes: a line pressure generating valve that generates a line pressure by adjusting a hydraulic pressure from an oil pump; a secondary pressure generating valve that generates a secondary pressure, which is a hydraulic pressure supplied to the back-pressure side oil chamber, by adjusting a hydraulic pressure from the line pressure generating valve so as to be lower than the line pressure; and a clutch engagement pressure generating valve that generates a clutch engagement pressure, which is a hydraulic pressure supplied to the engagement side oil chamber, by adjusting the line pressure from the line pressure generating valve in order to engage the hydraulic clutch.

The hydraulic control device includes the secondary pressure generating valve that generates the secondary pressure by adjusting the pressure of hydraulic oil drained from the line pressure generating valve so as to be lower than the line pressure; and the clutch engagement pressure generating valve that generates the clutch engagement pressure by adjusting the line pressure from the line pressure generating valve. To engage the hydraulic clutch, the clutch engagement pressure from the clutch engagement pressure generating valve is supplied to the engagement side oil chamber, and the secondary pressure from the secondary pressure generating valve is supplied to the back-pressure side oil chamber. Thus, the hydraulic pressure within the back-pressure side oil chamber and the engagement side oil chamber, i.e., the difference in pressure between the back-pressure side oil chamber and the engagement side oil chamber, can be suitably set based on the engagement state (e.g., fully engaged or slip-controlled state) of the hydraulic clutch without making the control of the secondary pressure generating valve and the clutch engagement pressure generating control valve more complex.

The hydraulic clutch may be a lock-up clutch that directly couples an input member connected to a motor and an input shaft of a transmission in a locked-up state and cancels the locked-up state, and the back-pressure side oil chamber may communicate with a fluid transmission chamber in which power is transmitted through hydraulic oil between an input-side fluid transmission element and an output-side fluid transmission element that configure a fluid transmission device. If the hydraulic control device is applied to the above configuration, a sufficient amount of hydraulic oil is supplied from the secondary pressure generating valve to the fluid transmission chamber through the back-pressure side oil chamber, and it is possible to suppress the occurrence of cavitation when there is a large difference between the rotation speeds of the input-side fluid transmission element and the output-side fluid transmission element. By increasing (raising) a source pressure of the clutch engagement pressure faster than the secondary pressure, it is possible to well secure a difference in pressure between the clutch engagement pressure supplied to the engagement side oil chamber and the secondary pressure supplied to the back-pressure side oil chamber even if the rotation speed of the motor is low. Therefore, it is possible to set the lock-up clutch to a fully engaged or slip-controlled state even while the rotation speed of the motor is low.

The line pressure generating valve may generate the line pressure by adjusting the hydraulic pressure from the oil pump in accordance with a control pressure that is set based on a drive power request for the motor, and the secondary pressure generating valve may generate the secondary pressure by adjusting the pressure of hydraulic oil drained from the line pressure generating valve so as to be lower than the line pressure based on the control pressure. Accordingly, when the drive power request (torque request) for the motor is large, the secondary pressure to be supplied to the back-pressure side oil chamber can be increased in accordance with the drive power request so that a sufficient amount of oil within the back-pressure side oil chamber and the fluid transmission chamber can be ensured. In addition, the line pressure serving as the source pressure of the clutch engagement pressure can also be increased in accordance with the drive power request at such time. Therefore, the difference in pressure between the engagement side oil chamber and the back-pressure side oil chamber can be suitably set even if the secondary pressure supplied to the back-pressure side oil chamber is increased. Thus, according to the above configuration, an increase in the size of the oil pump can be suppressed and the generation of heat in the lock-up clutch (hydraulic clutch) can be suppressed. At the same time, it is also possible to lock up the lock-up clutch in a smooth manner when the rotation speed of the motor is low, as well as smoothly slip the lock-up clutch when the torque output from the motor is high, and expand the slip area of the lock-up clutch. When the drive power request is small, the secondary pressure to be supplied to the back-pressure side oil chamber can be decreased in accordance with the drive power request so that an increase in the amount of oil within the back-pressure side oil chamber and the fluid transmission chamber can be suppressed.

Hydraulic oil drained from the secondary pressure generating valve may be supplied to a lubrication target. In addition, a drain oil passage connected to the secondary pressure generating valve and an oil passage connected to a pressure regulating port of the secondary pressure generating valve may communicate with each other through an orifice. Thus, until the secondary pressure sufficiently increases based on the increase in the line pressure and a sufficient amount of hydraulic oil can be supplied from the secondary pressure generating valve, a portion of the hydraulic oil from the pressure regulating port of the secondary pressure generating valve can flow out to the drain oil passage so as to supply a sufficient amount of hydraulic oil to the lubrication target.

The oil passage connected to the pressure regulating port of the secondary pressure generating valve may include an oil amount restricting mechanism that adjusts an amount of hydraulic oil flowing out to the lubrication target through the orifice. Thus, the amount of hydraulic oil flowing out to the lubrication target through the orifice can be even better adjusted.

The clutch engagement pressure generating valve may include a first port that is supplied with a clutch control pressure for generating the clutch engagement pressure, a second port that is supplied with the line pressure, a third port that is supplied with the secondary pressure, a fourth port that outputs the clutch engagement pressure, a fifth port that is supplied with the clutch engagement pressure output from the fourth port as a feedback pressure, and a sixth port that drains a portion of the line pressure. In a non-pressure-regulated state in which the clutch control pressure is not supplied to the first port, the second port may be closed and the fourth port and the sixth port may communicate with each other. In a pressure-regulated state in which the clutch control pressure is supplied to the first port, the fifth port may be supplied with the clutch engagement pressure output from the fourth port, the third port may be supplied with the secondary pressure, and the second port and the fourth port may communicate with each other. Thus, the clutch engagement pressure can be generated by adjusting the line pressure using the secondary pressure.

The lock-up clutch may be a multi-plate clutch. That is, according to the present invention, the difference in pressure between the engagement side oil chamber and the back-pressure side oil chamber of the multi-plate clutch that is relatively more susceptible to generating heat can be more suitably set.

### BRIEF DESCRIPTION OF THE DRAWINGS

FIG. 1 is a schematic configuration diagram of an automobile 10, which is a vehicle mounted with a power transmission device 20 that includes a hydraulic control device 50 according to an embodiment of the present invention;

FIG. 2 is a schematic configuration diagram that shows the power transmission device 20;

FIG. 3 is an operation chart that shows the relationship between the operation states of clutches and brakes, and the shift speeds of an automatic transmission 40 included in the power transmission device 20;

FIG. 4 is a system diagram that shows an essential portion of the hydraulic control device 50; and

FIG. 5 is a system diagram that shows an essential portion of a hydraulic control device 50B according to a modification.

### DETAILED DESCRIPTION OF THE EMBODIMENT

Next, an embodiment of the present invention will be described.

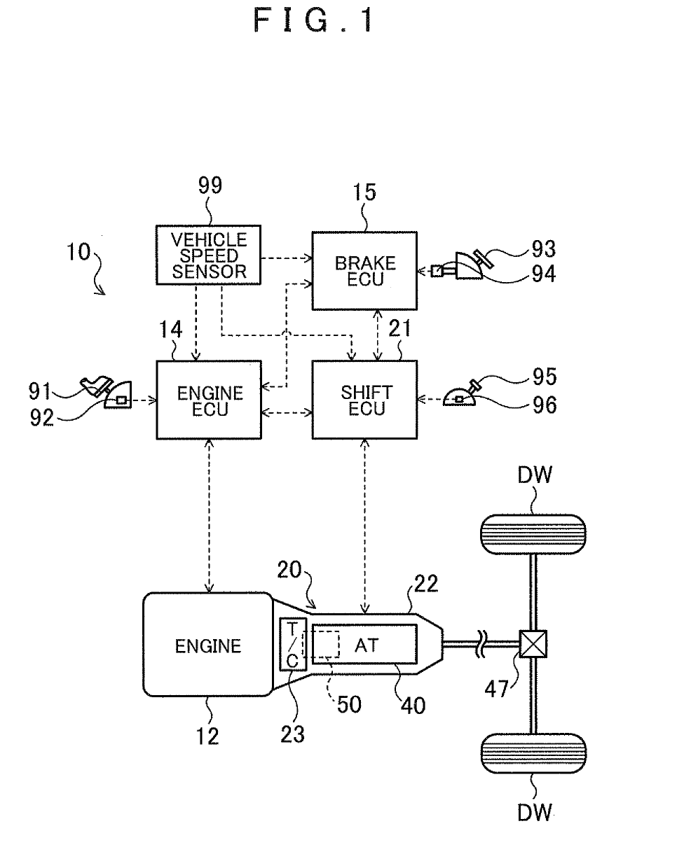

FIG. 1 is a schematic configuration diagram of an automobile 10, which is a vehicle mounted with a power transmission device 20 that includes a hydraulic control device according to an embodiment of the present invention. The automobile 10 shown in the figure includes an engine 12, an engine electronic control unit (hereinafter, “engine ECU”) 14, a brake electronic control unit (hereinafter, “brake ECU”) 15, and the power transmission device 20. The engine 12 is an internal combustion engine that outputs power from an explosive combustion of a mixture of air and hydrocarbon fuel such as gasoline or diesel. The engine ECU 14 controls the operation of the engine 12. The brake ECU 15 controls an electronically controlled hydraulic brake unit (not shown). The power transmission device 20 includes a torque converter 23 that is a fluid transmission device and a stepped automatic transmission 40, a hydraulic control device 50 that supplies and discharges hydraulic oil (hydraulic fluid) to and from these, and a shift electronic control unit (hereinafter, “shift ECU”) 21 that controls these. The power transmission device 20 is connected to a crankshaft 16 of the engine 12 serving as a motor, and transmits power from the engine 12 to left and right drive wheels DW.

As shown in FIG. 1, the engine ECU 14 is input with signals from various sensors such as an accelerator operation amount Acc from an accelerator pedal position sensor 92 that detects a depression amount (operation amount) of an accelerator pedal 91 indicating the degree of a drive power request (torque request) from the driver for the engine 12, a vehicle speed V from a vehicle speed sensor 99, and a signal from a crankshaft position sensor (not shown) that detects the rotation of the crankshaft 16. The engine ECU 14 is also input with signals from the brake ECU 15 and the shift ECU 21. Based on such signals, the engine ECU 14 controls electronically controlled throttle valves, fuel injection valves, ignition plugs (none of which are shown), and the like. The brake ECU 15 is input with a master cylinder pressure detected by a master cylinder pressure sensor 94 when a brake pedal 93 is depressed, the vehicle speed V from the vehicle speed sensor 99, signals from various sensors (not shown), and signals from the engine ECU 14 and the shift ECU 21. Based on such signals, the brake ECU 15 controls a brake actuator (hydraulic actuator, not shown) and the like.

The shift ECU 21 of the power transmission device 20 is accommodated inside a transmission case 22. The shift ECU 21 is input with a shift range SR from a shift range sensor 96 that detects the operation position of a shift lever 95 for selecting a desired shift range from among a plurality of shift ranges, the vehicle speed V from the vehicle speed sensor 99, signals from various sensors (not shown), and signals from the engine ECU 14 and the brake ECU 15. Based on such signals, the shift ECU 21 controls the torque converter 23, the automatic transmission 40, and the like. Note that the engine ECU 14, the brake ECU 15, and the shift ECU 21 are each configured as a microprocessor with a CPU (not shown) as its core. In addition to the CPU, the engine ECU 14, the brake ECU 15, and the shift ECU 21 each include a ROM that stores processing programs, a RAM that temporarily stores data, input/output ports, and a communication port (none of which are shown). The engine ECU 14, the brake ECU 15, and the shift ECU 21 are also connected to each other through bus lines or the like, and the exchange of various data required for control is executed as necessary among these ECUs.

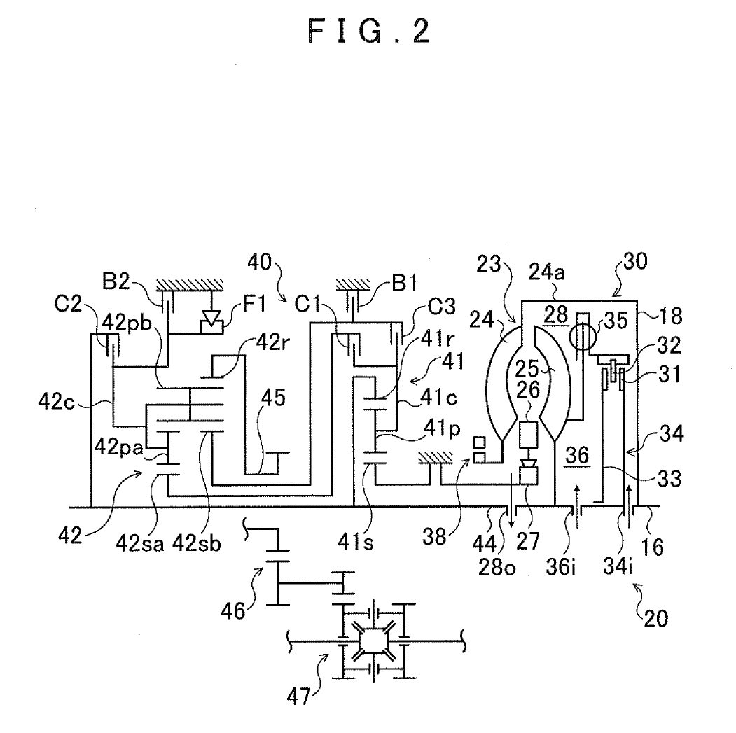

The power transmission device 20 further includes the torque converter 23, an oil pump 38, and the automatic transmission 40 accommodated inside the transmission case 22. The torque converter 23 is configured as a fluid torque converter with a lock-up clutch. As shown in FIG. 2, the torque converter 23 includes a pump impeller (input-side fluid transmission element) 24 that is connected to the crankshaft 16 of the engine 12 through a front cover 18; a turbine runner (output-side fluid transmission element) 25 that is fixed to an input shaft (input member) 44 of the automatic transmission 40 through a turbine hub; a stator 26 that is disposed inward of the pump impeller 24 and the turbine runner 25 and rectifies the flow of hydraulic oil (ATF) from the turbine runner 25 to the pump impeller 24; and a one-way clutch 27 that restricts the rotation of the stator 26 to one direction. The pump impeller 24, the turbine runner 25, and the stator 26 form a torus (ring-like flow path) that circulates hydraulic oil within a fluid transmission chamber 28 that is defined by the front cover 18 and a pump shell 24a of the pump impeller 24. Within the fluid transmission chamber 28, power is transmitted through hydraulic oil between the pump impeller 24 serving as the input-side fluid transmission element and the turbine runner 25 serving as the output-side fluid transmission element. In other words, the torque converter 23 functions as a torque amplifier by the action of the stator 26 when there is a large difference in the rotation speeds of the pump impeller 24 and the turbine runner 25, and functions as a fluid coupling when the rotation speed difference between the two is small.

The torque converter 23 of the embodiment further includes a lock-up clutch 30 capable of directly coupling the front cover 18 and the input shaft 44 of the automatic transmission 40 in a locked-up state, and canceling the locked-up state. The lock-up clutch 30 is configured as a multi-plate hydraulic clutch. The lock-up clutch 30 includes a clutch plate 31 that is fixed to the front cover 18; a clutch plate 32 that is slidably supported by a clutch hub that is connected to the turbine runner 25 through a lock-up damper 35; and a lock-up piston 33 that is disposed slidable in the axial direction inside the front cover 18 so as to be capable of pressing the clutch plate 32 against the clutch plate 31. A back-pressure side oil chamber 34 that includes a hydraulic oil inlet 34i and communicates with the fluid transmission chamber 28 is defined on one side (right side in FIG. 2), i.e., the front cover 18 side, of the lock-up piston 33. An engagement side oil chamber 36 that includes a hydraulic oil inlet 36i is defined on the other side (left side in FIG. 2), i.e., the fluid transmission chamber 28 side, of the lock-up piston 33.

The hydraulic oil inlet 34i of the back-pressure side oil chamber 34 is constantly supplied with hydraulic oil from the hydraulic control device 50 during operation of the engine 12, thus filling the back-pressure side oil chamber 34 and the inside of the fluid transmission chamber 28 that is in communication with the back-pressure side oil chamber 34 with hydraulic oil. Excess hydraulic oil within the fluid transmission chamber 28 flows outside from a hydraulic oil outlet 28o. Once the automobile 10 starts off, if a predetermined lock-up condition or a slip control condition that slips the lock-up clutch 30 using a slip control is established, hydraulic oil is guided to the engagement side oil chamber 36 through the hydraulic oil inlet 36i so that the lock-up piston 33 is moved toward the back-pressure side oil chamber 34 side. Thus, the clutch plate 32 is sandwiched by the lock-up piston 33 and the clutch plate 31 that is fixed to the front cover 18 to fully engage or slip the lock-up clutch 30, whereby power from the engine 12 can be transmitted to the input shaft 44 of the automatic transmission 40 through the lock-up clutch 30. Note that torque fluctuations from the pump impeller 24 side that occur during engagement of the lock-up clutch are absorbed by the lock-up damper 35.

The oil pump 38 is configured as a gear pump that includes a pump assembly formed from a pump body and a pump cover; and an external gear that is connected to the pump impeller 24 of the torque converter 23 through a hub. The oil pump 38 is also connected to the hydraulic control device 50. When power from the engine 12 rotates the external gear, the oil pump 38 causes hydraulic oil accumulated in an oil pan (not shown) to be suctioned and discharged through a strainer (not shown), thereby generating a hydraulic pressure required by the torque converter 23 and the automatic transmission 40 and supplying hydraulic oil to lubrication sections such as various bearings.

The automatic transmission 40 is configured as a six-speed stepped automatic transmission. As shown in FIG. 2, the automatic transmission 40 includes a single-pinion type first planetary gear mechanism 41, and a Ravigneaux type second planetary gear mechanism 42, as well as three clutches C1, C2, and C3, two brakes B1 and B2, and a one-way clutch F1 for changing a power transmission path from the input side to the output side. The single-pinion type first planetary gear mechanism 41 includes a sun gear 41s that is an external gear fixed to the transmission case 22; a ring gear 41r that is an internal gear concentrically disposed with the sun gear 41s and connected to the input shaft 44; a plurality of pinion gears 41p that meshes with the sun gear 41s and meshes with the ring gear 41r; and a carrier 41c that rotatably and revolvably holds the plurality of pinion gears 41p. The Ravigneaux type second planetary gear mechanism 42 includes two sun gears 42sa, 42sb that are external gears; a ring gear 42r that is an internal gear fixed to an output shaft 45 of the automatic transmission 40; a plurality of short pinion gears 42pa that meshes with the sun gear 42sa; a plurality of long pinion gears 42pb that meshes with the sun gear 42sb and the plurality of short pinion gears 42pa, and also meshes with the ring gear 42r; and a carrier 42c that is supported by the transmission case 22 through the one-way clutch F1, and rotatably and revolvably holds the plurality of short pinion gears 42pa and the plurality of long pinion gears 42pb that are connected to each other. The output shaft 45 of the automatic transmission 40 is connected to the drive wheels DW through a gear mechanism 46 and a differential mechanism 47.

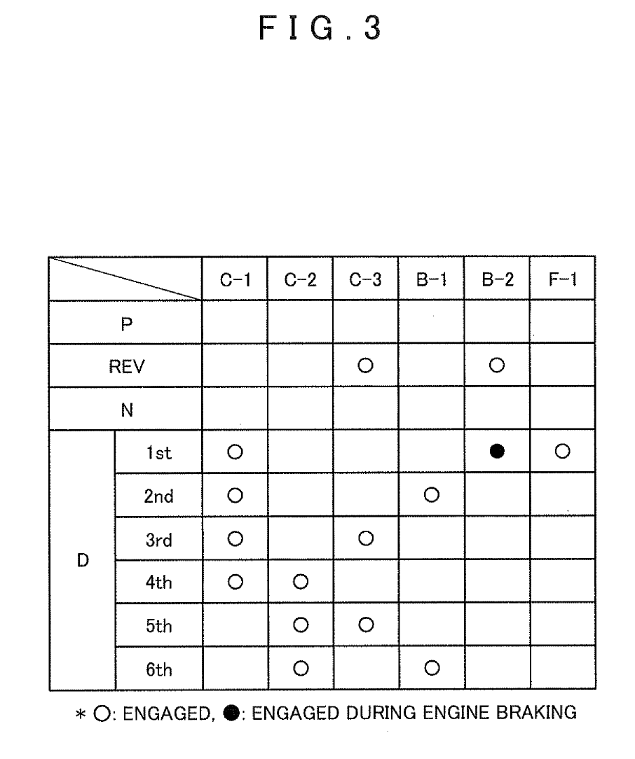

The clutch C1 is a hydraulic clutch that can couple and uncouple the carrier 41c of the first planetary gear mechanism 41 and the sun gear 42sa of the second planetary gear mechanism 42. The clutch C2 is a hydraulic clutch that can couple and uncouple the input shaft 44 and the carrier 42c of the second planetary gear mechanism 42. The clutch C3 is a hydraulic clutch that can couple and uncouple the carrier 41c of the first planetary gear mechanism 41 and the sun gear 42sb of the second planetary gear mechanism 42. The brake B1 is a hydraulic clutch that can hold the sun gear 42sb of the second planetary gear mechanism 42 stationary to the transmission case 22 and cancel such holding of the sun gear 42sb to the transmission case 22. The brake B2 is a hydraulic clutch that can hold the carrier 42c of the second planetary gear mechanism 42 stationary to the transmission case 22 and cancel such holding of the carrier 42c to the transmission case 22. The clutches C1 to C3 and the brakes B1 and B2 are operated through the supply and discharge of hydraulic oil by the hydraulic control device 50. FIG. 3 is an operation chart that shows the relationship between the operation states of the clutches C1 to C3 and the brakes B1 and B2, and the shift speeds of the automatic transmission 40. The automatic transmission 40 provides first to sixth forward speeds and one reverse speed by setting the clutches C1 to C3 and the brakes B1 and B2 to the states shown in the operation chart of FIG. 3.

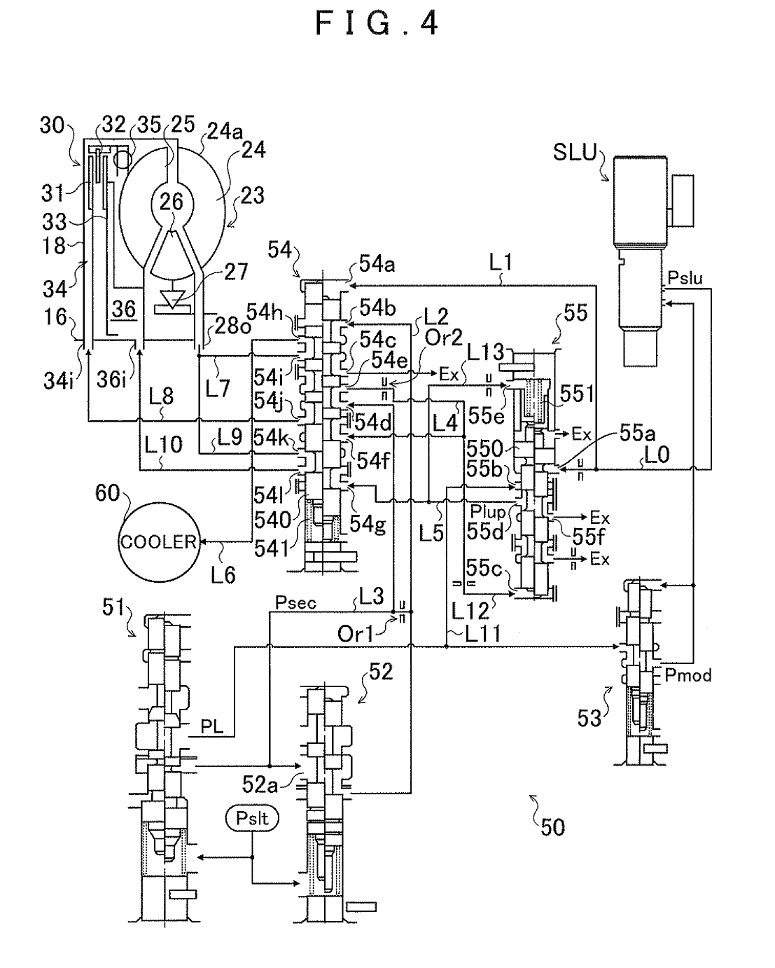

FIG. 4 is a system diagram that shows an essential portion of the hydraulic control device 50 that supplies and discharges hydraulic oil to and from the automatic transmission 40 and the torque converter 23 that includes the lock-up clutch 30 described above. The hydraulic control device 50 is connected to the oil pump 38 described earlier that uses power from the engine 12 to suction and discharge hydraulic oil from the oil pan (not shown). The hydraulic control device 50 includes a valve body (not shown), a primary regulator valve (line pressure generating valve) 51, a secondary regulator valve (secondary pressure generating valve) 52, a modulator valve 53, manual valves (not shown), and a plurality of linear solenoid valves (not shown). The primary regulator valve 51 generates a line pressure PL by adjusting the pressure of hydraulic oil from the oil pump 38, which is driven by a control pressure Pslt from a linear solenoid valve (not shown) that outputs the control pressure Pslt by adjusting the pressure of hydraulic oil from the oil pump 38 side (modulator valve 53 described later) based on the accelerator operation amount Ace or the throttle valve opening. The secondary regulator valve 52 generates a secondary pressure (circulation pressure) Psec by adjusting the pressure of hydraulic oil drained from the primary regulator valve 51 such that the secondary pressure Psec is lower than the line pressure PL based on the control pressure Pslt. The modulator valve 53 generates a relatively high and substantially fixed modulator pressure Pmod by adjusting the line pressure PL. Depending on the operation position of the shift lever 95, the manual valves can supply hydraulic oil from the primary regulator valve to the clutches C1 to C3 and the brakes B1 and B2, and also stop the supply of hydraulic oil to the clutch C1 and the like. The plurality of linear solenoid valves can each regulate the pressure (line pressure PL) of hydraulic oil from the manual valves and output such pressure to the corresponding clutches C1 to C3 and brakes B1, B2 sides. Spools, springs, and the like of the linear solenoid valves, the primary regulator valve 51, the secondary regulator valve 52, and the modulator valve 53 are all disposed in valve holes formed in the valve body.

As shown in FIG. 4, the hydraulic control device 50 further includes a lock-up solenoid valve SLU, a lock-up relay valve 54, and a lock-up control valve 55 (clutch engagement pressure generating valve). The lock-up solenoid valve SLU includes a linear solenoid (not shown) that is energized and controlled by the shift ECU 21, and generates a lock-up solenoid pressure (clutch control pressure) Pslu that is a control pressure for generating a lock-up pressure (clutch engagement pressure) Plup that is supplied to the engagement side oil chamber 36 when maintaining the lock-up clutch 30 in a state immediately prior to engagement, or slipping the lock-up clutch 30 based on the slip control, or fully engaging the lock-up clutch 30. The lock-up relay valve 54 can supply and discharge hydraulic oil to and from the back-pressure side oil chamber 34, the engagement side oil chamber 36, and the fluid transmission chamber 28. The lock-up control valve 55 generates the lock-up pressure Plup by adjusting the line pressure PL from the primary regulator valve 51 based on the lock-up solenoid pressure Pslu from the lock-up solenoid valve SLU.

The lock-up relay valve 54 is a switching valve that is driven by the lock-up solenoid pressure Pslu from the lock-up solenoid valve SLU. The lock-up relay valve 54 is configured as a spool valve that includes a spool 540 that has a plurality of lands and is slidably disposed in a valve hole formed in the valve body, and a spring 541 that biases the spool 540 upward in the figure. The lock-up relay valve 54 of the embodiment includes a signal pressure input port 54a that communicates with an output port of the lock-up solenoid valve SLU through oil passages L0 and L1 formed in the valve body; a drain input port 54b that is supplied with hydraulic oil drained from the secondary regulator valve 52 through an oil passage L2 formed in the valve body; a discharge oil port 54c; a first secondary pressure input port 54d that is supplied with the secondary pressure Psec through an oil passage L3 formed in the valve body and connected to a pressure regulating port 52a of the secondary regulator valve 52; a secondary pressure output port 54e that can communicate with the first secondary pressure input port 54d; a second secondary pressure input port 54f that can communicate with the secondary pressure output port 54e through an oil passage L4 formed in the valve body; a lock-up pressure input port 54g that is supplied with the lock-up pressure Plup from the lock-up control valve 55 through an oil passage L5 formed in the valve body; an outflow port 54h that communicates with a hydraulic oil inlet of an oil cooler 60 through an oil passage L6 formed in the valve body; a first inflow port 54i that communicates with the hydraulic oil outlet 28o of the fluid transmission chamber 28 of the torque converter 23 through an oil passage L7 formed in the valve body; a first output port 54j that communicates with the hydraulic oil inlet 34i of the back-pressure side oil chamber 34 through an oil passage L8 formed in the valve body; a second inflow port 54k that communicates with the hydraulic oil outlet 28o of the fluid transmission chamber 28 through an oil passage L9 formed in the valve body and a portion of the oil passage L7; and a second output port 54l that communicates with the hydraulic oil inlet 36i of the engagement side oil chamber 36 through an oil passage L10 formed in the valve body. Note that the ports of the lock-up relay valve 54 are all formed in the valve body (likewise for the ports of the lock-up control valve 55). In addition, hydraulic oil flowing into the oil cooler 60 is cooled by the oil cooler 60 and subsequently supplied to lubrication targets, i.e., the automatic transmission 40 and various bearings.

In the hydraulic control device 50 of the embodiment, the oil passage L2 that guides hydraulic oil drained from the secondary regulator valve 52 to the drain input port 54b of the lock-up relay valve 54 and the oil passage L3 that guides hydraulic oil under the secondary pressure Psec from the secondary regulator valve 52 to the first secondary pressure input port 54d of the lock-up relay valve 54 communicate with each other through a first orifice Or1. Within the oil passage L4 that communicates with the secondary pressure output port 54e and the second secondary pressure input port 54f of the lock-up relay valve 54, a second orifice Or2 serving as an oil amount restricting mechanism is provided at a position near the secondary pressure output port 54e.

In the embodiment, the attachment state (off state) of the lock-up relay valve 54 corresponds to the left half of the valve in FIG. 4. When the lock-up solenoid valve SLU does not generate the lock-up solenoid pressure Pslu and the lock-up solenoid pressure Pslu is not supplied to the signal pressure input port 54a, the lock-up relay valve 54 is maintained in the attachment state, i.e., off state. In the off state, the spring 54l biases the spool 540 upward in the figure such that the upper end of the spool 540 in the figure contacts the valve body. Thus, the discharge oil port 54c and the secondary pressure output port 54e are in communication, the first secondary pressure input port 54d and the first output port 54j are in communication, the second secondary pressure input port 54f and the lock-up pressure input port 54g are closed, the outflow port 54h and the first inflow port 54i are in communication, and the second inflow port 54k and the second output port 54l are in communication.

On the other hand, when the lock-up solenoid valve SLU generates the lock-up solenoid pressure Pslu and the lock-up solenoid pressure Pslu is supplied to the signal pressure input port 54a, the lock-up relay valve 54 moves to the state (on state) indicated by the right half of the valve in FIG. 4, wherein the spool 540 moves downward in the figure against the biasing force of the spring 54l and the lower end of the spool 540 in the figure contacts a lid element that is fixed to the valve body. In the on state, the drain input port 54b and the outflow port 54h are in communication, the discharge oil port 54c and the first inflow port 54i are in communication, the first secondary pressure input port 54d and the secondary pressure output port 54e are in communication, the second secondary pressure input port 54f and the first output port 54j are in communication, the lock-up pressure input port 54g and the second output port 54l are in communication, and the second inflow port 54k is closed by the spool 540. Note that the length and interval of the lands of the spool 540, the spring constant of the spring 54l, the position of each port, and the like of the lock-up relay valve 54 are set such that the switching of the oil passages as described above is executed based on whether the lock-up solenoid pressure Pslu is input to the signal pressure input port 54a.

The lock-up control valve 55 is a pressure regulating valve that is driven by the lock-up solenoid pressure Pslu from the lock-up solenoid valve SLU. The lock-up control valve 55 is configured as a spool valve that includes a spool 550 that has a plurality of lands and is slidably disposed in a valve hole formed in the valve body, and a spring 551 that biases the spool 550 downward in the figure. The lock-up control valve 55 of the embodiment includes a control pressure input port (first port) 55a that communicates with the output port of the lock-up solenoid valve SLU through the oil passage L0 and an orifice formed in the valve body; a line pressure input port (second port) 55b that communicates with a pressure regulating port of the primary regulator valve 51 that generates the line pressure PL, which is the source pressure of the lock-up solenoid pressure Pslu, through an oil passage L11 formed in the valve body; a port (third port) 55c that communicates with the oil passage L4 that links the secondary pressure output port 54e and the second secondary pressure input port 54f of the lock-up relay valve 54 through an oil passage L12 and an orifice formed in the valve body, and communicates with an oil chamber that is defined downward in the figure of the end portion of the spool 550 that does not contact the spring 551; an output port (fourth port) 55d that communicates with the lock-up pressure input port 54g of the lock-up relay valve 54 through the oil passage L5; a feedback port (fifth port) 55e that communicates with the oil passage L5 that links the output port 55d and the lock-up pressure input port 54g of the lock-up relay valve 54 through an oil passage L13 and an orifice fanned in the valve body, and communicates with a spring chamber in which the spring 551 is disposed; and a drain port (sixth port) 55f.

In the embodiment, the lock-up solenoid pressure Pslu supplied to the control pressure input port 55a acts on pressure receiving surfaces of two lands formed on the spool 550. According to the embodiment, among these two lands, the pressure receiving surface (outer diameter) of the land on the top side (spring 551 side) of the valve in the figure is set larger than the pressure receiving surface (outer diameter) of the land on the bottom side (opposite side from the spring 551) of the valve in the figure, the pressure receiving surface of the spool 550 that receives hydraulic pressure supplied to the port 55c, and the pressure receiving surface of the spool 550 (plunger) that receives hydraulic pressure supplied to the feedback port 55e. Between the two lands of the spool 550 that receive the lock-up solenoid pressure Pslu, an oil chamber is defined by a difference in the pressure receiving areas of the two lands. This oil chamber is in constant communication with the control pressure input port 55a.

The attachment state (non-pressure-regulating state) of the lock-up control valve 55 thus configured corresponds to the right half of the valve in FIG. 4, When the lock-up solenoid valve SLU does not generate the lock-up solenoid pressure Pslu and the lock-up solenoid pressure Pslu is not supplied to the control pressure input port 55a, the lock-up control valve 55 is configured so as to maintain the attachment state. In the attachment state, the spring 551 biases the spool 550 downward in the figure such that the lower end of the spool 550 in the figure contacts the valve body. Thus, the line pressure input port 55b is closed, and the output port 55d and the drain port 55f are in communication. Accordingly, the hydraulic oil (line pressure PL) supplied to the line pressure input port 55b is not output from the output port 55d.

On the other hand, when the lock-up solenoid valve SLU generates the lock-up solenoid pressure Pslu, the lock-up solenoid pressure Pslu is supplied to the control pressure input port 55a of the lock-up control valve 55. A portion of the hydraulic oil flowing out from the output port 55d is supplied to the feedback port 55e through the oil passage L13 and the orifice. Supplying the lock-up solenoid pressure Pslu to the signal pressure input port 54a causes a portion of the hydraulic oil flowing through the oil passage L4 that links the secondary pressure output port 54e and the second secondary pressure input port 54f of the lock-up relay valve 54 to be supplied to the port 55c through the oil passage L12 and the orifice. The thrust applied to the spool 550 by the action of the lock-up solenoid pressure Pslu and the thrust applied to the spool 550 by the action of the hydraulic pressure from the port 55c thus overcome the biasing force of the spring 551 and the thrust applied to the spool 550 by the action of the hydraulic pressure supplied to the feedback port 55e. Therefore, the spool 550 moves upward in the figure (to the state indicated by the left half of the valve in FIG. 4, i.e., pressure-regulating state), and the movement of the spool 550 gradually closes the drain port 55f. In addition, as the spool 550 moves upward in the figure, the line pressure input port 55b gradually opens, and the amount of hydraulic oil flowing out through the drain port 55f simultaneously decreases accordingly. The line pressure PL supplied to the line pressure input port 55b is thus adjusted. As the lock-up solenoid pressure Pslu increases, the lock-up pressure Plup output from the output port 55d also gradually increases. Once the lock-up solenoid pressure Pslu reaches a predetermined value, the lock-up pressure Plup corresponds to a value required to fully engage the lock-up clutch 30.

Next, the operation of the hydraulic control device 50 described above will be explained.

When the lock-up solenoid valve SLU does not generate the lock-up solenoid pressure Pslu and the lock-up solenoid pressure Pslu is not supplied to the signal pressure input port 54a of the lock-up relay valve 54, that is, when the lock-up clutch 30 is not engaged, the secondary pressure Psec from the secondary regulator valve 52 that is supplied to the first secondary pressure input port 54d of the lock-up relay valve 54 in the off state is further supplied to the back-pressure side oil chamber 34 and the fluid transmission chamber 28 through the first output port 54j, the oil passage L8, and the hydraulic oil inlet 34i. The hydraulic oil flowing through the fluid transmission chamber 28 flows into the oil cooler 60 through the hydraulic oil outlet 28o, the oil passage L7, the first inflow port 54i and the outflow port 54h of the lock-up relay valve 54, and the oil passage L6. In addition, the hydraulic oil flows into the engagement side oil chamber 36 through the oil passage L9, the second inflow port 54k and the second output port 54l of the lock-up relay valve 54, and the oil passage L10.

The secondary pressure Psec that is adjusted in accordance with the control pressure Pslt based on the accelerator operation amount Acc or the throttle valve opening, that is, a drive power request for the engine 12, is thus supplied to the back-pressure side oil chamber 34 and the fluid transmission chamber 28. Therefore, when the lock-up clutch 30 is not engaged and the drive power request for the engine 12 is large, the secondary pressure Psec to be supplied to the back-pressure side oil chamber 34 can be increased in accordance with the drive power request so that a sufficient amount of oil within the back-pressure side oil chamber 34 and the fluid transmission chamber 28 can be ensured. It is thus possible to suppress an increase in the size of the oil pump 38, and also suppress the occurrence of cavitation when there is a large difference between the rotation speeds of the pump impeller 24 and the turbine runner 25. In addition, when the lock-up clutch 30 is not engaged and the drive power request for the engine 12 is small, the secondary pressure Psec to be supplied to the back-pressure side oil chamber 34 can be decreased in accordance with the drive power request so that an increase in the amount of oil within the back-pressure side oil chamber 34 and the fluid transmission chamber 28 can be suppressed.

On the other hand, when the lock-up solenoid pressure Pslu is supplied form the lock-up solenoid valve SLU to the signal pressure input port 54a of the lock-up relay valve 54, that is, when the lock-up clutch 30 is engaged (e.g., fully engaged or slip-controlled), the secondary pressure Psec from the secondary regulator valve 52 that is supplied to the first secondary pressure input port 54d of the lock-up relay valve 54 in the on state through the oil passage L3 is further supplied to the back-pressure side oil chamber 34 and the fluid transmission chamber 28 through the secondary pressure output port 54e, the oil passage L4, the second secondary pressure input port 54f, the first output port 54j, the oil passage L8, and the hydraulic oil inlet 34i.

In addition, when the lock-up clutch 30 is fully engaged, slip-controlled, or the like, the lock-up solenoid pressure Pslu from the lock-up solenoid valve SLU is supplied to the control pressure input port 55a of the lock-up control valve 55. The lock-up control valve 55 thus adjusts the line pressure PL supplied to the line pressure input port 55b based on the lock-up solenoid pressure Pslu, and generates the lock-up pressure Plup. The lock-up pressure Plup that is supplied from the lock-up control valve 55 to the lock-up pressure input port 54g of the lock-up relay valve 54 through the oil passage L5 is further supplied through second output port 54l, the oil passage L10, and the hydraulic oil inlet 36i to the engagement side oil chamber 36 that is opposite the back-pressure side oil chamber 34 with the lock-up piston 33 interposed therebetween. Accordingly, in the hydraulic control device 50 of the embodiment, controlling the lock-up solenoid valve SLU to vary (increase) the lock-up pressure Plup from the lock-up control valve 55 controls a difference in pressure between the back-pressure side oil chamber 34 and the engagement side oil chamber 36, whereby the lock-up clutch 30 can be fully engaged, slipped, or set to stand by in a state immediately prior to engagement. By increasing (raising) the source pressure of the lock-up pressure Plup faster than the secondary pressure Psec, it is possible to well secure a difference in pressure between the lock-up pressure Plup supplied to the engagement side oil chamber 36 and the secondary pressure Psec supplied to the back-pressure side oil chamber 34 even if the rotation speed of the engine 12 is low. Therefore, the lock-up clutch 30 can be fully engaged or slip-controlled in a smooth manner even while the rotation speed of the engine 12 is low.

During times when the lock-up clutch 30 is fully engaged, slip-controlled, or the like, the secondary pressure Psec that is adjusted in accordance with the control pressure Pslt based on the drive power request for the engine 12 is supplied to the back-pressure side oil chamber 34 and the fluid transmission chamber 28. Therefore, when the drive power request for the engine 12 is large, the secondary pressure Psec to be supplied to the back-pressure side oil chamber 34 can be increased in accordance with the drive power request so that a sufficient amount of oil within the back-pressure side oil chamber 34 and the fluid transmission chamber 28 can be ensured. In addition, the line pressure PL serving as the source pressure of the lock-up pressure Plup can also be increased in accordance with the drive power request for the engine 12 at such time. Therefore, the difference in pressure between the engagement side oil chamber 36 and the back-pressure side oil chamber 34 can be suitably set even if the secondary pressure Psec supplied to the back-pressure side oil chamber 34 is increased. Thus, according to the hydraulic control device 50, an increase in the size of the oil pump 38 can be suppressed and the generation of heat in the lock-up clutch 30 can be suppressed. At the same time, it is also possible to lock up, that is, fully engage, the lock-up clutch 30 in a smooth manner when the rotation speed of the engine 12 is low, as well as smoothly slip the lock-up clutch 30 when the torque output from the engine 12 is high, and expand the slip control area of the lock-up clutch 30. Moreover, the occurrence of cavitation when there is a large difference between the rotation speeds of the pump impeller 24 and the turbine runner 25 can be suppressed. When the lock-up clutch 30 is fully engaged or slip-controlled and the drive power request for the engine 12 is small, the secondary pressure Psec to be supplied to the back-pressure side oil chamber 34 can be decreased in accordance with the drive power request so that an increase in the amount of oil within the back-pressure side oil chamber 34 and the fluid transmission chamber 28 can be suppressed.

Hydraulic oil flowing through the fluid transmission chamber 28 while the lock-up clutch 30 is fully engaged, slip-controlled, or the like flows out to the oil pan through the hydraulic oil outlet 28o, the oil passage L7, and the first inflow port 54i and the discharge oil port 54c of the lock-up relay valve 54. In addition, while the lock-up clutch 30 is fully engaged, slip-controlled, or the like, the drain input port 54b and the outflow port 54h of the lock-up relay valve 54 are in communication, and hydraulic oil drained from the secondary regulator valve 52 flows out to the oil cooler 60 through the outflow port 54h and the oil passage L6. Here, in the hydraulic control device 50 of the embodiment, the oil passage L2 that serves as a drain oil passage connected to the secondary regulator valve 52 and the oil passage L3 that is connected to the pressure regulating port 52a of the secondary regulator valve 52 communicate with each other through the orifice Or1. Thus, until the secondary pressure Psec sufficiently increases based on the increase in the line pressure PL and a sufficient amount of hydraulic oil can be supplied from the secondary regulator valve 52, a portion of the hydraulic oil from the pressure regulating port 52a of the secondary regulator valve 52 can flow out to the oil passage L2 so as to supply a sufficient amount of hydraulic oil to the oil cooler 60, that is, the lubrication targets. Note that the amount of hydraulic oil flowing out from the oil passage L3 (pressure regulating port 52a) to the oil passage L2 (drain input port 54b) can be set to any amount by adjusting the orifice diameters of the first and second orifices Or1, Or2.

As described above, the hydraulic control device 50 of the embodiment includes the secondary regulator valve 52 that generates the secondary pressure Psec by adjusting the pressure of hydraulic oil drained from the primary regulator valve 51 so as to be lower than the line pressure PL; and the lock-up control valve 55 that generates the lock-up pressure Plup by adjusting the line pressure PL from the primary regulator valve 51. To engage the lock-up clutch 30, the lock-up pressure Plup from the lock-up control valve 55 is supplied to the engagement side oil chamber 36 defined on the one side of the lock-up piston 33, and the secondary pressure Psec from the secondary regulator valve 52 is supplied to the back-pressure side oil chamber 34 defined on the other side of the lock-up piston 33. Thus, the hydraulic pressure within the back-pressure side oil chamber 34 and the engagement side oil chamber 36, i.e., the difference in pressure between the back-pressure side oil chamber 34 and the engagement side oil chamber 36, can be suitably set based on the engagement state (e.g., fully engaged or slip-controlled state) of the lock-up clutch 30 without making the control of the secondary regulator valve 52 and the lock-up control valve 55 more complex. In addition, by supplying a sufficient amount of hydraulic oil from the secondary regulator valve 52 to the fluid transmission chamber 28 through the back-pressure side oil chamber 34, it is possible to suppress the generation of heat in the lock-up clutch 30 and also suppress the occurrence of cavitation when there is a large difference between the rotation speeds of the pump impeller 24 and the turbine runner 25.

The primary regulator valve 51 of the hydraulic control device 50 generates the line pressure PL by adjusting the hydraulic pressure from the oil pump 38 in accordance with the control pressure Pslt that is set based on a drive power request for the engine 12, The secondary regulator valve 52 generates the secondary pressure Psec by adjusting the pressure of hydraulic oil drained from the primary regulator valve 51 so as to be lower than the line pressure PL based on the control pressure Pslt. Accordingly, when the drive power request (torque request) for the engine 12 is large, the secondary pressure Psec to be supplied to the back-pressure side oil chamber 34 can be increased in accordance with the drive power request so that a sufficient amount of oil within the back-pressure side oil chamber 34 and the fluid transmission chamber 28 can be ensured. Thus, an increase in the size of the oil pump 38 can be suppressed and the generation of heat in the lock-up clutch 30 can be suppressed. At the same time, it is also possible to fully engage the lock-up clutch 30 in a smooth manner when the rotation speed of the engine 12 is low, as well as smoothly slip the lock-up clutch 30 when the torque output from the engine 12 is high. When the drive power request for the engine 12 is small, the secondary pressure Psec to be supplied to the back-pressure side oil chamber 34 can be decreased in accordance with the drive power request. Consequently, an increase in the amount of oil within the back-pressure side oil chamber 34 and the fluid transmission chamber can be suppressed.

As described above, by communicating the oil passage L2 that serves as the drain oil passage connected to the secondary regulator valve 52 and the oil passage L3 that is connected to the pressure regulating port 52a of the secondary regulator valve 52 with each other through the orifice Or1, a portion of the hydraulic oil from the pressure regulating port 52a of the secondary regulator valve 52 can flow out to the oil passage L2 so as to supply a sufficient amount of hydraulic oil to the lubrication targets through the oil cooler 60 until the secondary pressure Psec sufficiently increases based on the increase in the line pressure PL and a sufficient amount of hydraulic oil can be supplied from the secondary regulator valve 52.

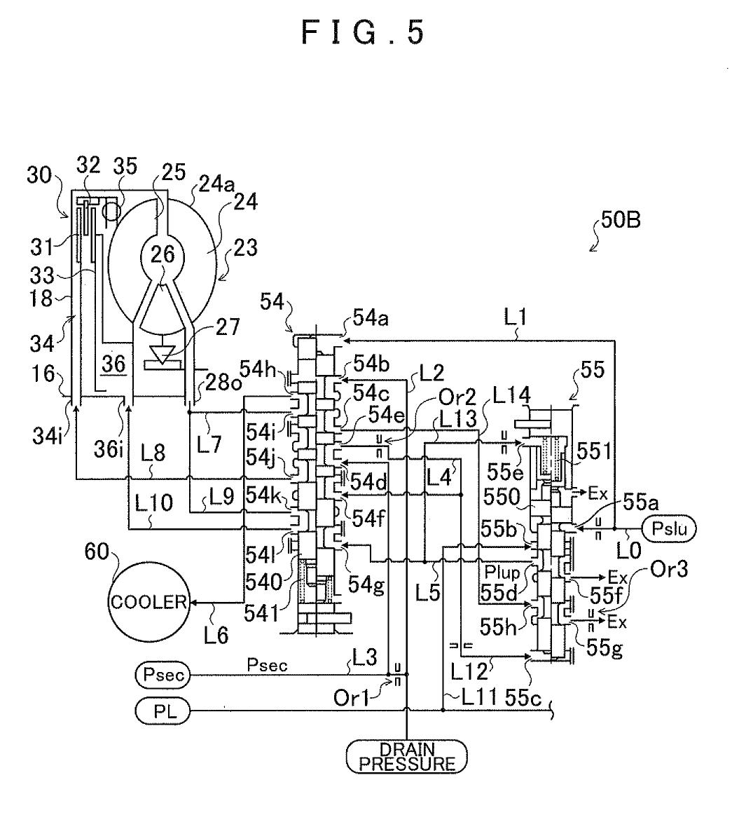

Note that, as shown by a hydraulic control device 50B in FIG. 5, the discharge oil port 54c that communicates with the first inflow port 54i when the lock-up solenoid pressure Pslu is supplied to the signal pressure input port 54a of the lock-up relay valve 54 may be connected through an oil passage L14 formed in the valve body to a port 55h that communicates with a port 55g of the lock-up control valve 55, which closes as the lock-up solenoid pressure Pslu increases when the lock-up solenoid pressure Pslu is supplied to the control pressure input port 55a of the lock-up control valve 55. In addition, an orifice Or3 may be provided near the port 55g. In the hydraulic control device 50B of FIG. 5, when the lock-up solenoid pressure Pslu is supplied to the signal pressure input port 54a of the lock-up relay valve 54 and the control pressure input port 55a of the lock-up control valve 55, the hydraulic oil flowing through the fluid transmission chamber 28 flows into the port 55h of the lock-up control valve 55 through the hydraulic oil outlet 28o, the oil passage L7, and the first inflow port 54i and the discharge oil port 54c of the lock-up relay valve 54. Since the port 55g of the lock-up control valve 55 closes as the lock-up solenoid pressure Pslu increases, when the lock-up clutch 30 is fully engaged, the outflow of hydraulic oil to the oil pan through the port 55g can be decreased or stopped. In other words, after fully engaging the lock-up clutch 30, the lock-up clutch 30 is less susceptible to generating heat. Therefore, the amount of hydraulic oil circulating in the fluid transmission chamber 28 can be decreased by restricting the discharge of hydraulic oil from the fluid transmission chamber 28 as described above. This configuration is particularly effective when applied to an automobile in which the lock-up clutch 30 is fully engaged while the rotation speed of the engine 12 is low and the lock-up clutch 30 is less susceptible to generating heat.

Although the difference in pressure between the engagement side oil chamber 36 and the back-pressure side oil chamber 34 of a multi-plate clutch that is relatively more susceptible to generating heat can be more suitably set according to the present invention, the lock-up clutch 30 may also be configured as a single-plate hydraulic clutch. Moreover, the present invention may be applied to a start-off clutch that is disposed between the engine and the transmission rather than in the torque converter, for example. Also, instead of the torque converter 23 that has a torque amplifying effect, the power transmission device 20 described above may include a fluid coupling that does not have a torque amplifying effect. Besides an automatic transmission, the hydraulic control device 50 and the torque converter 23 that includes the lock-up clutch 30 may be incorporated into a continuously variable transmission (CVT).

Here, the correspondence will be described between main elements in the embodiment and main elements of the invention as listed in the Summary of the Invention. Specifically, in the embodiment described above, the lock-up clutch 30 capable of directly coupling the front cover 18 connected to the engine 12 serving as a motor and the input shaft 44 of the automatic transmission 40 in a locked-up state and canceling the locked-up state corresponds to a “hydraulic clutch” and a “lock-up clutch”. The lock-up piston 33 corresponds to a “piston”. The engagement side oil chamber 36 defined on the one side of the lock-up piston 33 corresponds to an “engagement side oil chamber”. The back-pressure side oil chamber 34 defined on the other side of the lock-up piston 33 corresponds to a “back-pressure side oil chamber”. The hydraulic control devices 50, 50B correspond to a “hydraulic control device”. The primary regulator valve 51 that generates the line pressure PL by adjusting the hydraulic pressure from the oil pump 38 corresponds to a “line pressure generating valve”. The secondary regulator valve 52 that generates the secondary pressure Psec, which is a hydraulic pressure supplied to the back-pressure side oil chamber 34, by adjusting the pressure of hydraulic oil drained from the primary regulator valve 51 so as to be lower than the line pressure PL corresponds to a “secondary pressure generating valve”. The lock-up control valve 55 that generates the lock-up pressure Plup, which serves as a clutch engagement pressure that is a hydraulic pressure supplied to the engagement side oil chamber 36, by adjusting the line pressure PL from the primary regulator valve 51 to engage the lock-up clutch 30 corresponds to a “clutch engagement pressure generating valve”. The fluid transmission chamber 28 that transmits power through hydraulic oil while there is a difference between the rotation speeds of the pump impeller 24 and the turbine runner 25 corresponds to a “fluid transmission chamber”.

Note that the correspondence between the main elements of the embodiment and the main elements of the invention as listed in the Summary of the Invention is only one specific example for carrying out the invention explained in the Summary of the Invention, and does not limit the elements of the invention as described in the Summary of the Invention. In other words, any interpretation of the invention described in the Summary of the Invention shall be based on the description therein; the embodiment is merely one specific example of the invention described in the Summary of the Invention.

The above embodiment was used to describe an example for carrying out the present invention. However, the present invention is not particularly limited to such an example, and various modifications may obviously be adopted without departing from the scope of the present invention.

The present invention may be utilized in the manufacturing industry for hydraulic control devices.

What is claimed is:

1. A hydraulic control device controlling a hydraulic pressure in an engagement side oil chamber defined on one side of a piston that configures a hydraulic clutch, and a hydraulic pressure in a back-pressure side oil chamber defined on the other side of the piston, the hydraulic control device comprising:
a line pressure generating valve that generates a line pressure by adjusting a hydraulic pressure from an oil pump;
a secondary pressure generating valve that generates a secondary pressure, which is a hydraulic pressure supplied to the back-pressure side oil chamber, by adjusting a hydraulic pressure from the line pressure generating valve so as to be lower than the line pressure; and
a clutch engagement pressure generating valve that generates a clutch engagement pressure, which is a hydraulic pressure supplied to the engagement side oil chamber, by adjusting the line pressure from the line pressure generating valve.

2. The hydraulic control device according to claim 1, wherein
the hydraulic clutch is a lock-up clutch that directly couples an input member connected to a motor and an input shaft of a transmission in a locked-up state and cancels the locked-up state, and the back-pressure side oil chamber communicates with a fluid transmission chamber in which power is transmitted through hydraulic oil between an input-side fluid transmission element and an output-side fluid transmission element that configure a fluid transmission device.

3. The hydraulic control device according to claim 2, wherein
the line pressure generating valve generates the line pressure by adjusting the hydraulic pressure from the oil pump in accordance with a control pressure that is set based on a drive power request for the motor, and
the secondary pressure generating valve generates the secondary pressure by adjusting the pressure of hydraulic oil drained from the line pressure generating valve so as to be lower than the line pressure based on the control pressure.

4. The hydraulic control device according to claim 1, wherein
hydraulic oil drained from the secondary pressure generating valve is supplied to a lubrication target, and
a drain oil passage connected to the secondary pressure generating valve and an oil passage connected to a pressure regulating port of the secondary pressure generating valve communicate with each other through an orifice.

5. The hydraulic control device according to claim 4, wherein
the oil passage connected to the pressure regulating port of the secondary pressure generating valve includes an oil amount restricting mechanism that adjusts an amount of hydraulic oil flowing out to the lubrication target through the orifice.

6. The hydraulic control device according to claim 1, wherein
the clutch engagement pressure generating valve includes
a first port that is supplied with a clutch control pressure for generating the clutch engagement pressure,
a second port that is supplied with the line pressure,
a third port that is supplied with the secondary pressure,
a fourth port that outputs the clutch engagement pressure,
a fifth port that is supplied with the clutch engagement pressure output from the fourth port as a feedback pressure, and
a sixth port that drains a portion of the line pressure, wherein
in a non-pressure-regulated state in which the clutch control pressure is not supplied to the first port, the second port is closed and the fourth port and the sixth port communicate with each other, and
in a pressure-regulated state in which the clutch control pressure is supplied to the first port, the fifth port is supplied with the clutch engagement pressure output from the fourth port, the third port is supplied with the secondary pressure, and the second port and the fourth port communicate with each other.

7. The hydraulic control device according to claim 1, wherein
the lock-up clutch is a multi-plate clutch.
